(19) United States
(12) Patent Application Publication
(10) Pub. No.: US 2008/0169305 A1
(43) Pub. Date: Jul. 17, 2008

(54) Method of vending bottles and cans

(75) Inventor: William Charles Stevenson, Chatsworth, CA (US)

Correspondence Address: WILLIAM C. STEVENSON, 22353 DEVONSHIRE STREET, CHATSWORTH, CA, 91311, US

(73) Assignee: DB DESIGN INCORPORATED, CULVER CITY, CA (US)

(21) Appl. No.: 11/652,999

(22) Filed: Jan. 12, 2007

(51) Int. Cl. B65G 59/00

(52) U.S. Cl. 221/67

(57) ABSTRACT

An improved can/bottle vending mechanism made from self-lubricating thermoplastic resin, that includes a positionable wall and ramp that aligns bottles and cans for reliable dispensing during a vend, regardless of can or bottle dimensions within a rage is disclosed.

### BACKGROUND OF THE INVENTION

1. Field of the invention

The present field of the invention relates to an improved positionable mechanism that aligns various sizes of bottles and cans for dispensing from a vending machine. The mechanism is installed within the vending machine and is used to align variable sized bottles and cans against a single unit dispensing mechanism. The improved positionable mechanism is sized to occupy the excess space difference between the bottles or cans being vended and the opening space of the supply magazine from which the bottle or can is vended. The improved mechanism is made of materials that have a natural lubricity, which aids in preventing jams and smoothes the mechanical action of the vend cycle.

2. Description of the prior art

Product vending machines have been present in the marketplace since the Nineteenth Century. Each vending machine has the ability to store a quantity of pre-packaged products in a secure environment, then, in response to the input of a quantity of cash, one or more of the stored product packages is brought forward from the stock of stored products and dispensed to a location such as a protected shelf for the vending customer to take physical possession of their purchase.

Among the earliest popular vended products sold are bottled and canned beverages. At the onset of commercial vending, the variety of beverage container shapes and sizes presented a dilemma to machine manufacturers. The goal of the modern vending machine manufacturer is to provide a lowest cost, highest reliability, highest security dispensing mechanism with the ability to accept and dispense a variety of container sizes and shapes without having to reinvent the dispensing mechanism whenever a new bottle or can variety comes to market.

The result is that there are two commonly accepted gravity fed bottle and can dispensing mechanisms generally used in today's modern packaged beverage vending machines. One mechanism is a vertical column magazine made up of four vertical walls, (left, right, front and rear) which align the beverage containers over a single unit releasing mechanism at the magazine's bottom level. The other favored mechanism, and the one of interest in this present invention, is one consisting of two parallel vertical walls supporting shelves that are slanted such that generally cylindrical cans and bottles may drop from upper to lower shelves by rolling down slope aided by gravity.

This second favored mechanism, generally called a “rolling can lane” by the vending industry, is typically made up of two or more storage layers consisting of sloping shelves that store the beverage containers horizontally on their generally cylindrical side surfaces, allowing the containers to roll down the slope via gravity to the down slope end, where they may then drop off to the next shelf below. In practical use, this mechanism appears as multiple upper shelves that tilt down from front to rear between parallel supporting vertical walls positioned on left and right extremes, and a lower sloped shelf that has a tilt down from rear to front, where the single unit dispense mechanism is positioned. The bottommost shelf allows the beverage cans or bottles to roll against the exit point of the single unit dispense mechanism for final delivery to the customer. To ensure reliable dispensing cans and bottles must be accurately aligned with the dispensing mechanism, and to prevent jamming the supply of bottles and cans must also be in horizontal alignment with each other. The simplest method for accomplishing this alignment using this storage and vend mechanism is to position the two parallel vertical walls such that the distance between them is equal to the container's horizontal length plus a fraction of an inch. As cans and bottles are typically cylindrical in shape, and their ends are generally parallel, this method is sufficient to ensure a proper alignment of the containers as they roll along in-line down each sloped shelf.

This rolling can lane sloped shelf storage and vending mechanism may jam inoperably, should the cans or bottles misalign or if they twist off-axis on the various sloped shelves while on their way to the single unit release mechanism that follows. Further, the favored single unit release mechanism for this application is frequently a screw auger, sized to the general diameter of the vended bottle or can. A screw mechanism like this will jam if the can or bottle is not completely aligned such that the screw auger may reliably separate that can or bottle from the remainder of the gravity fed stock of beverage containers, and feed this segregated unit to the customer pick-up location. At first, this approach resulted in sloped shelf storage and single unit dispense mechanisms that were specific to only a narrowly defined size and shape of can or bottle, and any change made by the can or bottle manufacturer could naturally cause such a mechanism to be unreliable or entirely unusable.

A perfectly aligned sloped shelf storage and feed magazine positions the top and bottom surfaces of the supply of cans or bottles such that the cans or bottles remain horizontally aligned as they roll down the sloped shelf and are not allowed to twist off their rolling axis during their travel. This continual dynamic positioning also brings the now aligned containers to the dispensing screw auger. Over time, advancements in design allowed the introduction of customized spacers to take up any difference in opening space between the vertical walls of the sloped shelf storage and feed magazine and the overall horizontal length of the vended bottle or can dimensions, effectively repositioning one or both parallel vertical side walls. The spacer on the bottommost shelf, (the shelf having the dispense mechanism at its end) may also be designed such that it provides an extra final alignment via an entry end ramp to funnel and thus shift the bottles or cans horizontally toward one side wall or the other for beverage container alignment with the dispense mechanism.

This is the condition of today's vending machine development that, to accommodate a variety of sizes and lengths of bottles and cans, several application specific spacers and guides are required to perform the function of reducing the available feed space to a perfectly dimensioned feed space for a variety of bottles or cans. Each spacer generally becomes dedicated to a specific bottle or can dimension. Selection, installation and use of such spacers can be difficult, as they are usually installed at locations within the vending machine where there is limited access or space to undertake manually manipulating the spacer into its mounting position. Further, almost all such spacers are manufactured from galvanized sheet steel, which has the negative aspects of associated fabrication costs and significantly limited design choices that may be made in creating a specific spacer. Another factor of galvanized steel is its high surface friction coefficient, which can contribute to bottles or cans twisting off-axis during gravitational down slope transport and then jamming the dispense screw auger. Additionally, sheet metal construction may typically result in sharp edges and corners, and snagging burrs that may pose an injury hazard to anyone servicing or installing such assemblies.

It is therefore an object of the present invention to produce a reliable spacer of complex three dimensional form not obtainable using sheet metal fabrication techniques. A second object of the invention is to improve the rolling and alignment characteristics of the spacer mechanism by reducing or eliminating interfacial friction between the mechanism and the beverage containers being stored and dispensed by it. A third object of the invention is to incorporate improved fabrication methods that result in improved design characteristics and reduced manufacturing cost over traditional sheet metal fabrication methods. It is also an object of this present invention to eliminate the likelihood of human injury caused by sharp edged or pointed sheet metal protrusions frequently produced by sheet metal fabrication methods.

### SUMMARY OF THE INVENTION

The present invention improved method of vending bottles and cans is directed to provide an improved thermoformed plastic spacer mechanism to adjust the storage, feed and dispense openings of a vending machine's rolling can lane so that the machine may accommodate a wider variety of beverage container types, styles and sizes, reliably vending them from a secure storage environment. Applying this invention to a vending machine increases its utility as the machine may be more easily and reliably adjusted to sell many different sized and shaped packaged beverage choices. As new beverage products become available to the vending industry, a machine using this improved spacer mechanism is less likely to become obsolete or unusable.

In an exemplary embodiment of the invention, a flat sheet of thermoformable plastic resin that also has low coefficient of friction properties, such as certain nylon, acetal, polyolefin and fluoropolymer plastic resins and resin blends, is vacuum-formed to create a vertically positioned wall essentially spaced parallel from the permanent vertical wall supporting a sloped horizontal shelf. Further, the vertical wall of the spacer transitions into a blended ramp cam that forces the rolling bottle or can away from the permanent wall surface toward the spacer wall surface, and thus aligns the to be vended container with the dispensing mechanism. This form has a vertical view cross-section that approximates a slope beginning at the upslope intersection of the sloped horizontal shelf and stationary vertical wall surface, which slope then angles away from the permanent vertical wall to a point where the slope line now turns essentially parallel with the permanent wall surface and offset from that surface by a desired distance. The thermoforming process used also creates all the support walls and mounting flanges necessary to produce a finished mechanism that is reliable and robust for the application.

In a preferred embodiment of the present invention, the thermoformed resin spacer consists of a first essentially flat planar surface that corresponds to the vertical surface to which the spacer will be attached. This first planar surface is fabricated post-thermoforming to create application specific positioning tabs and mounting flanges and holes necessary to install and successfully use the spacer in a specific vending machine application. The thermoforming process creates an essentially trapezoidal top view cross-section “pan” shape having an outline that comprises a first essentially straight line that corresponds to the mounting surface, this line then makes an essentially right angle turn perpendicular away from the first essentially straight line for approximately the length of the desired offset distance less thermoformed material thickness, the line then makes a second essentially right angle turn that places the third essentially straight line essentially parallel to the first line and the three lines now forming three sides of a rectangle. The third essentially straight line has a length approximately greater than the diameter of bottle or can to be positioned for dispensing, and at its terminal end the line then makes an oblique angle turn toward the first essentially straight line where the two lines then intersect at an acute angle, thus forming an essentially trapezoidal outline. Perpendicular to this view, the cross-sectional outline of the form is that of a vertically oriented flanged rectangular channel comprised of a first vertical essentially straight line intersected by a second essentially perpendicular straight line essentially the length of the desired offset less thermoformed material thickness, the terminus of which ends at a third essentially vertical perpendicular line moving away from and essentially paralleling the first line for a distance sufficient to effectively guide the alignment of a vended bottle or can, then a fourth essentially perpendicular line intersects the end of the third line returning the fourth line toward and terminating at the intersection with the first line's plane, where a fifth line angles perpendicular to the fourth line in a continuation of the plane of the first line. This preferred embodiment improved spacer is ideally produced from a thermoformable sheet of low friction coefficient plastic resin having a pebbled or uneven outer surface that further reduces interfadal contact resistance and friction between the finished spacer's surface and the bottle or can being vended. This preferred embodiment of the present invention has multiple advantages over earlier sheet metal constructed spacers; which advantages are reduced fabrication cost, improved mechanical performance and reliability, corrosion immunity, improved installation process and improved safety.

Further features and advantages of the present invention will be appreciated by a review of the following detailed description when taken in conjunction with the following drawings.

### BRIEF DESCRIPTION OF THE DRAWINGS

The present invention may be best understood by referring to the following description of the preferred embodiments and the accompanying drawings, wherein like numerals denote like elements and in which:

FIG. 1 is an isometric view of the first exemplary embodiment of the invention thermoformed plastic resin spacer device.

FIG. 2 is a top view of a dedicated size vending machine “rolling can lane” mechanism's bottom dispense level, illustrating beverage containers lined up upon a sloped dispensing shelf in relation to a single unit dispense mechanism.

FIG. 3 is a top view of a vending machine's variable sized “rolling can lane” bottom dispense layer, illustrating beverage containers being accurately guided by the invention spacer device as they are lined up upon the sloped shelf in relation to a single unit dispense mechanism.

FIG. 4 is an isometric view of a vending machine's “rolling can lane” assembly illustrating the relationship of stored and vended beverage containers to the dynamic aligning characteristics of the invention thermoformed plastic resin spacer device.

### DETAILED DESCRIPTION OF THE PREFERRED EMBODIMENTS

The following exemplary discussion focuses upon the improved characteristics of an adjustable size range packaged beverage vending mechanism. Such mechanisms are a benefit to vending machine owners, as they allow a given vending machine greater flexibility of offering products that are newer and more popular than those the vending machine was originally used for. Their purpose is to allow secure storage of a variety of packaged beverage container sizes, feed and align the beverage containers to a reliable single unit dispensing mechanism and thus allow the beverage containers to be dispensed one at a time to the vending customer. The present invention is an improvement over existing vending mechanisms, in that it allows the vending machine manufacturer to produce more effective adjustment devices at lower cost, improved performance and higher reliability. The present invention improvement is appropriate for use in packaged beverage vending machines that incorporate what is commonly known as a “rolling can lane,” to store and dispense essentially cylindrical beverage containers of various sizes and lengths.

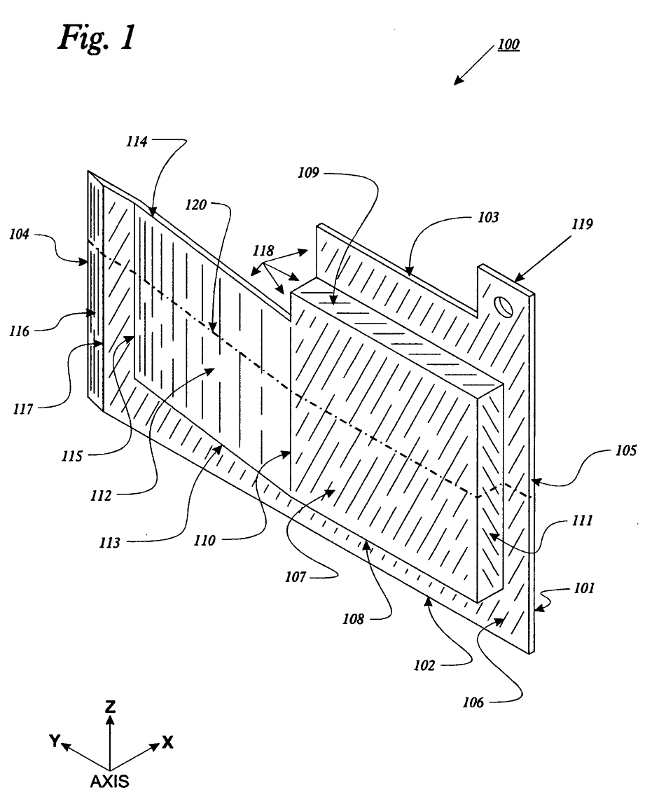

First referring to FIG. 1, an isometric view diagram of a first exemplary embodiment of the invention thermoformed plastic resin spacer device 100 made in accordance with the present invention is shown. The device 100 is a first essentially flat vertical plane 101 that is bounded by a bottom edge 102, a top edge 103, a rear edge 104 and a front edge 105. A second essentially flat vertical plane 106 essentially parallels first vertical plane at an offset equal to the thickness of plastic resin sheet material the spacer device 100 is thermoformably fabricated from, and shares the bottom 102, top 103 and front 105 boundaries of first vertical surface 101. A third essentially flat vertical plane 107 that is also essentially parallel with first vertical plane 101 is offset from first vertical plane 101 by the desired repositioning distance of the spacer device 100. Vertical plane 107 is bounded on three edges, bottom edge 108, top edge 109 and front edge 111, by thermoformed material drawn between first vertical plane 101 and third vertical plane 107 thus forming essentially perpendicular walls therebetween. The rear edge 110 of third vertical plane 107 transitionally connects to a fourth essentially vertical plane 112, which vertical plane 112 then angles rearward to transitionally intersect 115 second vertical plane 106 at a desirable distance from intersecting rear edge 110. Angled fourth vertical plane 112 is further bounded by bottom edge 113 and top edge 114. Bottom edge 113 of angled fourth vertical plane 112, is also thermoformed material drawn between first vertical plane 101 and third vertical plane 107 thus forming an essentially perpendicular triangle wall (not visible here).

Referring again to FIG. 1, second vertical plane 106 is bounded at the rear edge 117 by transitioning to fifth essentially vertical plane 116 which itself angles toward first vertical plane 101 to intersection at rear edge 104. The invention thermoformed plastic resin spacer device 100 creates a cam form outline 120, beginning at rear vertical edge 104, angling outward from first essentially vertical surface 101 to intersect rear boundary edge 117 of second essentially vertical surface 106, then intersecting rear boundary edge 115 of fourth essentially vertical surface 112 and angling away from first essentially vertical surface 101 until intersecting with rear boundary edge 110 of third vertical plane 107, then continues forward to intersect the front boundary edge 111 of third vertical plane 107 and makes a turn toward first vertical plane 101 until intersecting with second vertical plane 106, the cam form outline 120 then continues forward to intersect with second vertical plane front boundary edge 105 where the cam form outline 120 turns again toward first vertical plane 101 where the cam form outline 120 terminates at intersection of first vertical surface 101 and boundary edge 105.

The invention thermoformed plastic resin spacer device 100 may also be trimmed after thermoforming to include convenient features such as interference avoiding cut-away sections, such as represented by cutout 118, and also include mounting features such as are represented by tab with hole 119. These features aren't a requirement of the invention thermoformed plastic resin spacer device 100, but may be included as convenience features in making invention thermoformed plastic resin spacer device 100 more useful in its application.

Completing this discussion of FIG. 1, the three dimensional geometric shapes of vertical planes 101, 106, 107, 112 and 116 are illustrated herein as isometric view generally planar rectangular outlines comprising sharp corners and edges, which are the most common form for these desired features to take, and the only form economically possible when fabricating such spacer devices from sheet metal material. Using thermoforming methods for fabricating plastic sheet into complex curves and compound multi-dimensional geometric shapes allows design flexibility in improving the performance of cam form outline 120, thus creating a wide variety of invention thermoformed plastic resin spacer devices 100 that cannot be economically produced by any other method. Further, by incorporating low coefficient of friction properties, (for example—certain thermoformable nylon, acetal, polyolefin and fluoropolymer plastic resins and resin blends) in the manufacture of invention thermoformed plastic resin spacer devices 100 the installed performance of the device is improved dramatically as occurrences of miss-feeding and jamming of packaged beverage containers are reduced, or even eliminated. By varying the surface texture of vertical surfaces 106, 107, 112 and 104, even lower surface friction characteristics may be obtained. Such modifications may include ribs, ridges, bumps or other protrusions, or various combinations of such features as may additionally improve the operating dynamics or installation characteristics of invention thermoformed plastic resin spacer devices 100.

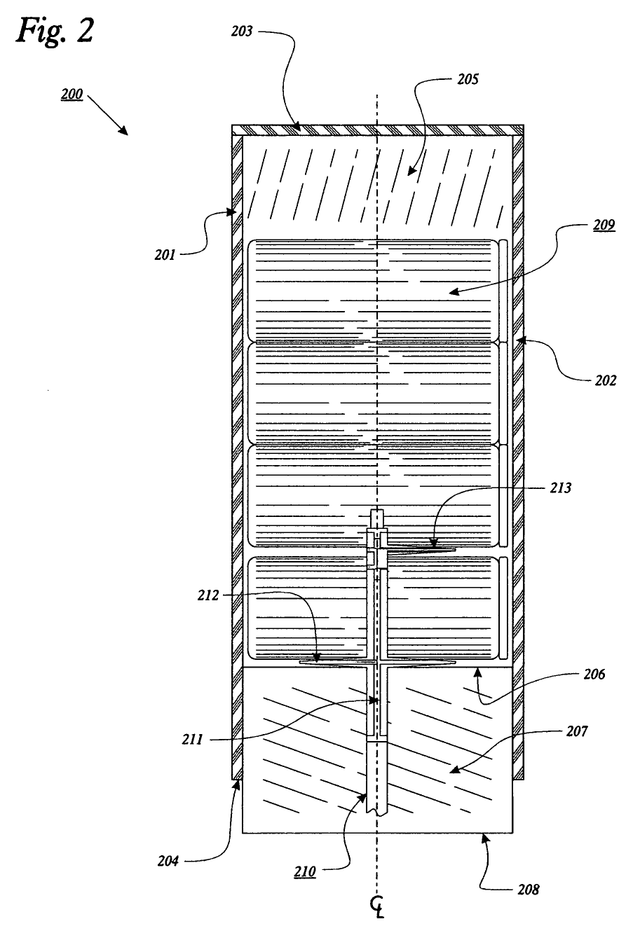

Referring now to FIG. 2, a top view of a known dedicated size packaged beverage container vending machine “rolling can lane” mechanism's bottom dispense level 200, illustrates beverage containers lined up upon a sloped dispensing shelf in relation to a single unit dispense mechanism. The rolling can lane mechanism is generally constructed as a box form, herein illustrated as a rectangle enclosed by a first vertical planar surface wall 201 at the left of this view, a second vertical planar surface wall 202 paralleling and offset to the right from first vertical planar surface wall 201 by a distance equal to the container length capacity of the packaged beverage container vending machine “rolling can lane” mechanism's bottom dispense level 200. Both first vertical planar surface wall 201 and second vertical planar surface wall 202 are joined together at the rear of the mechanism 200, by a third vertical planar surface wall 203, these three vertical planar surfaces describing a rectangle having three surfaces and terminating at front opening edge 204 of the mechanism bottom dispense level 200. A generally rectangular sloped shelf 205 is located interior of and supported by vertical planar surface walls 201, 202 and 203, beginning at an elevated position where sloped shelf 205 intersects vertical surface wall 203 and declining until terminating at sloped shelf's 205 front edge 206. Sloped shelf front edge 206 is offset toward the rear away from front opening edge 204 by a distance sufficient to position generally rectangular delivery shelf 207 between first and second vertical planar surface walls 201 and 202. Front edge 208 of generally rectangular delivery shelf 207 may extend beyond front opening edge 204.

Continuing with FIG. 2, a supply of generally cylindrical beverage containers 209, (herein illustrated as common aluminum pull-top cans, but may also be other generally cylindrical metal, glass or plastic bottles or cans) are sequentially positioned with their cylindrical axis oriented perpendicularly between first vertical planar surface wall 201 and second vertical planar surface wall 202 on sloped shelf 205. First vertical planar surface wall 201 and second vertical planar surface wall 202 are positioned parallel to each other at a distance equal to the axial length of generally cylindrical beverage containers 209, leaving only sufficient additional space to allow free movement of generally cylindrical beverage containers 209 in response to gravitational forces applied by sloped shelf 205. Supply of generally cylindrical beverage containers 209 rolls down-slope of sloped shelf 205 where they engage single unit dispense device 210 for secure retention until single unit dispense device 210 is activated for a vend. When the vend cycle is activated, the leading unit beverage container 209a is segregated from the supply of generally cylindrical beverage containers 209 and directed forward by the actuation so the leading unit beverage container 209a may drop to delivery shelf 207 for convenient retrieval by the vend customer.

The illustrated FIG. 2 single unit dispense device 210, (also commonly known as a “can or bottle auger”) approximately positioned along the centerline between vertical planar surface walls 201 and 202, comprises a shaft 211 whose axis is generally back to front of the packaged beverage container vending machine rolling can lane mechanism's bottom dispense level 200, a generally quarter-circular separator cam blade 212 axially positioned at the up-slope entry end of shaft 211, and a second generally semi-circular dispense cam 213 axially positioned forward of separator cam blade 212 a distance slightly greater than the diameter of individual units of beverage containers 209. Viewing the illustrated single unit dispense device 210 along its axis reveals that generally quarter-circular separator cam blade 212 is rotationally positioned from the 12 o'clock to the 3 o'clock axis angle, and the second generally semi-circular dispense cam 213 is rotationally positioned from the 3 o'clock axis angle to the 9 o'clock axis angle. In this start position, illustrated single unit dispense device 210 separates and captivates leading unit beverage container 209a from supply of generally cylindrical beverage containers 209, securing leading unit beverage container 209a until the single unit dispense device 210 is actuated. As shaft 211 rotates 360° once in a clock-wise direction, separator cam blade 212 engages the gap between leading unit beverage container 209a separating it from the supply of generally cylindrical beverage containers 209 at the same time the second generally semi-circular dispense cam 213 is rotationally positioned to release leading unit beverage container 209a to freely drop via gravity to delivery shelf 207.

Referring again to FIG. 2, one may easily understand that, by making the distance between vertical planar surface wall 201 and vertical planar surface wall 202 variable, a packaged beverage container vending machine rolling can lane mechanism may be created that is virtually infinitely adjustable in a minimum to maximum range of vended product container sizes. Such a goal may be achieved using the invention thermoformed plastic resin spacer device 100 made in accordance with the present invention method.

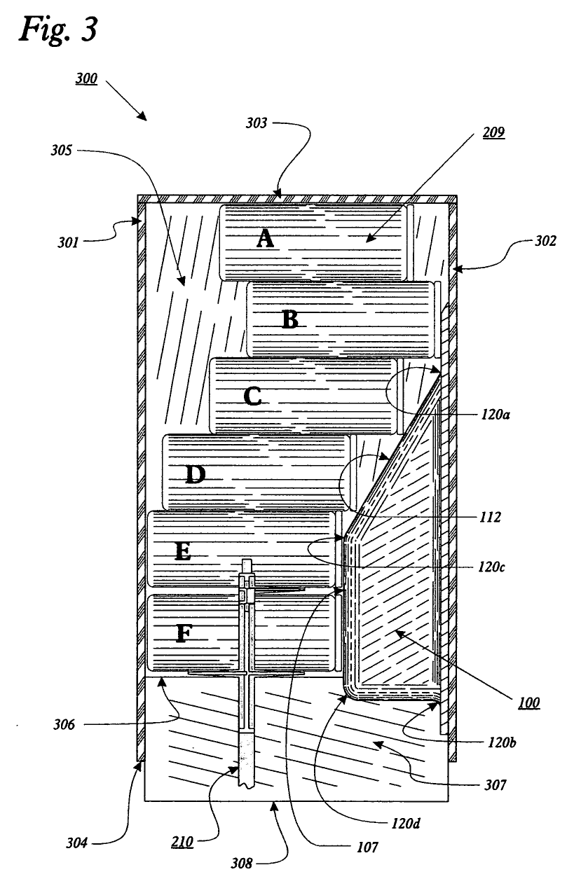

Moving on to FIG. 3, a top view of a vending machine's variable sized rolling can lane bottom dispense layer 300, illustrating beverage containers 209 being accurately guided by the preferred embodiment of invention spacer device 100, as they are lined up upon the sloped dispensing shelf 305 in relation to a single unit dispense mechanism 210. This vending machine variable sized rolling can lane bottom dispense mechanism is generally constructed as a box form, herein illustrated as a rectangle enclosed by a first vertical planar surface wall 301 at the left of this view, a second vertical planar surface wall 302 paralleling and offset to the right from first vertical planar surface wall 301 by a distance equal to the maximum container axial length capacity of the packaged beverage container vending machine rolling can lane mechanism's bottom dispense level 300. Both first vertical planar surface wall 301 and second vertical planar surface wall 302 are joined together at the rear of the mechanism 300, by a third vertical planar surface wall 303, these three vertical planar surfaces describing a rectangle having three surfaces and terminating at front opening edge 304 of the mechanism bottom dispense level 300. A generally rectangular sloped shelf 305 is located interior of and supported by vertical planar surface walls 301, 302 and 303, beginning at an elevated position where sloped shelf 305 intersects rear vertical surface wall 303 and declining until terminating at sloped shelf's 305 front edge 306. Sloped shelf front edge 306 is offset toward the rear away from front opening edge 304 by a distance sufficient to position generally rectangular delivery shelf 307 between first and second vertical planar surface walls 301 and 302. Front edge 308 of generally rectangular delivery shelf 307 may extend beyond front opening edge 304.

Now, continuing with FIG. 3, a supply of generally cylindrical beverage containers 209, (herein illustrated as common aluminum pull-top cans, but may also be other generally cylindrical metal, glass or plastic bottles or cans) are sequentially positioned with their cylindrical axis oriented perpendicularly between first vertical planar surface wall 301 and second vertical planar surface wall 302 on sloped shelf 305. First vertical planar surface wall 301 and second vertical planar surface wall 302 are positioned parallel to each other at a distance equal to the maximum axial length of generally cylindrical beverage containers 209, leaving only sufficient additional space to allow free movement of generally maximum axial length cylindrical beverage containers 209 in response to gravitational forces applied by sloped shelf 305. Supply of generally cylindrical beverage containers 209 rolls down-slope of sloped shelf 305 where they engage single unit dispense device 210 for secure retention until single unit dispense device 210 is activated for a vend. When the vend cycle is activated, the leading unit beverage container A is segregated from the supply of generally cylindrical beverage containers 209 and directed forward by the actuation so the leading unit beverage container A may drop to delivery shelf 307 for convenient retrieval by the vend customer.

In FIG. 3, the supply of generally cylindrical beverage containers 209 is illustrated as common aluminum pull-top cans that are considerably shorter in their axial length than the space available between first vertical planar surface wall 301 and second vertical planar surface wall 302. As a result, the supply of generally cylindrical beverage containers 209 is illustrated as being in various stages of lateral misalignment with each other and with a single unit dispense mechanism 210, as they may appear in a duplicate real-life vending situation. A preferred embodiment invention thermoformed plastic resin spacer device 100 is illustrated installed flat against the interior surface of vertical planar surface wall 302. As the supply of generally cylindrical beverage containers 209 gravitationally advance down-slope at each actuation of the single unit dispense mechanism 210, the end of each beverage container 209 may come in contact with the surface of preferred embodiment invention thermoformed plastic resin spacer device 100, which is positioned, configured and properly sized to force the supply of beverage containers to usefully align with the single unit dispense mechanism 210. The six individual generally cylindrical beverage containers 209 illustrated herein are identified by the letters A through F, with the last container F shown perfectly aligned and engaged with the single unit dispense mechanism 210. As cans 209 advance down-slope on shelf 305, can A has not engaged preferred embodiment invention thermoformed plastic resin spacer device 100; can B has contacted the first surface 106 of thermoformed plastic resin spacer device 100; cans C & D have engaged slope 112; and cans E & F are aligned in final position by surface 107.

Referring still to FIG. 3, Note in this view that the preferred embodiment invention thermoformed plastic resin spacer device 100 is designed to incorporate inside and outside radius interfaces 120a, 120b, 120c and 120d at intersections between the various planes and angles of cam line 120, (not illustrated here). These radii soften the transitional forces needed to mechanically align individual packaged beverage containers 209 as they advance down-slope of shelf 305. See how can B is positioned approaching the intersection of slope 112. Without inside radius 120a, pull-top aluminum can B will engage a sharp oblique angle that may cause its lid rim to catch on the abrupt intersection with slope 112. This action may cause pull-top aluminum can B to twist counterclockwise on its vertical axis, which twisting may also then contribute to a jamming miss-alignment of cans 209 and single unit dispense mechanism 210. Such radii are very difficult to include in sheet metal fabricated cam acting spacers. Note also that cans C & B have engaged slope 112 with tangential contact there between, and this is an engagement that benefits greatly from a very low coefficient of friction such as offered by the preferred embodiment invention thermoformed plastic resin spacer device 100.

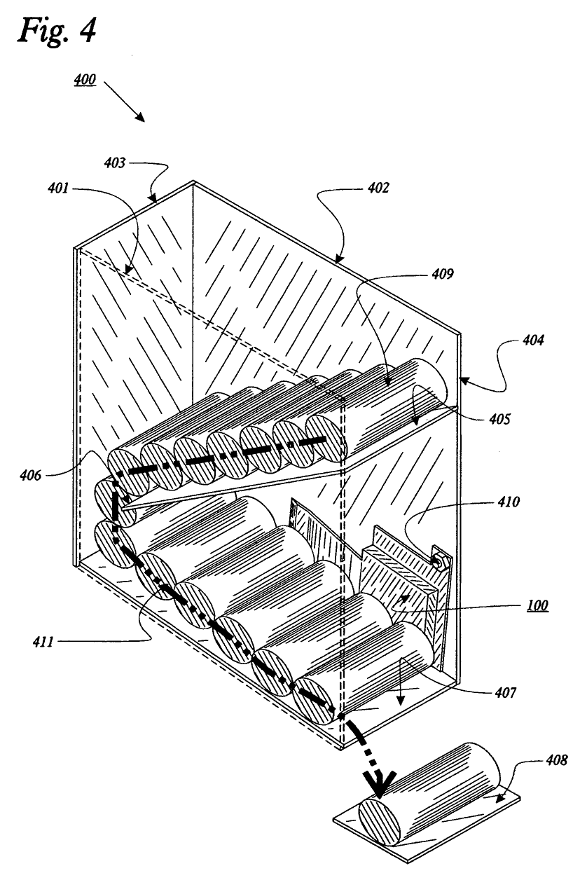

FIG. 4 is an isometric view of a vending machine's rolling can lane assembly 400 illustrating the relationship of stored and vended beverage containers to the dynamic aligning characteristics of the invention thermoformed plastic resin spacer device 100. This vending machine variable sized rolling can lane bottom dispense mechanism is generally constructed as a box form, herein illustrated as a rectangle enclosed by a first vertical planar surface wall 401, (illustrated as invisible dashed lines for clarity of view angle) at the left of this view, a second vertical planar surface wall 402 paralleling and offset to the right from first vertical planar surface wall 401 by a distance equal to the maximum container axial length capacity of the packaged beverage container vending machine rolling can lane mechanism's bottom dispense level 400. Both first vertical planar surface wall 401 and second vertical planar surface wall 402 are joined together at the rear of the mechanism 400, by a third vertical planar surface wall 403, these three vertical planar surfaces describing a rectangle having three solid surfaces and terminating at front opening edge 404 of the mechanism bottom dispense level 400. A first generally rectangular sloped shelf 405 is located interior of and supported by vertical planar surface walls 401 and 402, beginning at an elevated position where sloped shelf 405 intersects front edge vertical surface 404 and declining until terminating at sloped shelf's 405 rear edge 406. Sloped shelf rear edge 406 is offset away from rear third vertical planar surface wall 403 creating a gap therebetween that is greater than the cylindrical diameter of the largest packaged beverage container vended. A second generally rectangular sloped shelf 407 is located interior of and supported by vertical planar surface walls 401, 402 and 403, beginning at an elevated position where sloped shelf 407 intersects rear vertical surface wall 403 and declining until terminating at vertical planar surface wall 401 approximate front edge 404. A generally rectangular delivery shelf 408 is positioned proximately forward of edge 404 and at a lower elevation relative to the delivery end of second sloped shelf 407 thus providing a convenient location for the vend customer to retrieve their purchase. A preferred embodiment invention thermoformed plastic resin spacer device 100 is illustrated installed flat against the interior surface of vertical planar surface wall 402 using a common nut and screw 410 to secure it in position. As the supply of generally cylindrical beverage containers 409 gravitationally advance down-slope at each actuation of the single unit dispense mechanism, (not illustrated here) the end of each beverage container 409 may come in contact with the surface of preferred embodiment invention thermoformed plastic resin spacer device 100, which is positioned, configured and properly sized to force the supply of beverage containers to usefully align against the interior surface of first vertical surface wall 401. (For clarity, no single unit dispense mechanism is shown in this illustration.)

Continuing with FIG. 4, generally cylindrical beverage containers 409 are loaded into rolling can lane assembly 400 from the top elevation of first sloped shelf 405, allowing first and successive beverage containers 409 to roll down-slope to the open gap between edge 406 and rear vertical surface wall 403 and continue down-slope of second sloped shelf 407, thus filling the storage area with several generally cylindrical beverage containers 409. As the single unit dispense mechanism, (not illustrated here) releases a beverage container, said beverage container then rolls away from second sloped shelf 407 and falls onto delivery shelf 408. Bold line 412 illustrates the path followed by generally cylindrical beverage containers 409 as they are stored and dispensed from rolling can lane assembly 400. In practical application, rolling can lane assembly 400 will generally include additional first sloped shelf 405 elements positioned above the bottom-most sloped shelf 405 for increased product capacity.

In an alternative application use of the preferred embodiment invention thermoformed plastic resin spacer device 100, a second, mirror image preferred embodiment invention thermoformed plastic resin spacer device 100 may be positioned inboard of the opposite vertical planar surface wall 401, thus providing centering alignment of packaged beverage containers 409. In certain alternate applications where the differential in axial length between packaged beverage containers 409 and the width between opposite vertical planar surface walls 401 and 402 is great, dividing the alignment forces between two centering preferred embodiment invention thermoformed plastic resin spacer devices 100 may be preferred. In a third alternative application of preferred embodiment invention thermoformed plastic resin spacer device 100, two such devices are used that each possess application specific forms or shapes that relate to specific physical features appearing at opposite ends of the same generally cylindrical beverage container 209. It is not possible to economically reproduce this specific capability in another material or by another means.

The forgoing description includes what are at present considered to be preferred embodiments of the invention. However, it will be readily apparent to those skilled in the art that various changes and modifications may be made to the embodiments without departing from the spirit and scope of the invention. Accordingly, it is intended that such changes and modifications fall within the scope of the invention, and that the invention be limited only by the following claims.

What is claimed is:

1. An improved alignment spacer device thermoformed from plastic resin sheet possessing the characteristics of low surface coefficient of friction.

2. An improved alignment spacer device according to claim 1 that is thermoformed from olefin resin.

3. An improved alignment spacer device according to claim 1 that is thermoformed from polypropylene resin.

4. An improved alignment spacer device according to claim 1 that is thermoformed from nylon resin.

5. An improved alignment spacer device according to claim 1 that is thermoformed from acetal resin.

6. An improved alignment spacer device according to claim 1 that is thermoformed from fluropolymer resin.

7. An improved alignment spacer device thermoformed from plastic resin sheet that is a laminate structure of a first layer of plastic resin possessing the characteristics of low surface coefficient of friction and a second layer of plastic resin possessing the characteristics of increased stiffness and structural strength.

8. An improved alignment spacer device according to claim 7 that is thermoformed from a laminate of olefin and styrene resins.

9. An improved alignment spacer device according to claim 7 that is thermoformed from a laminate of olefin and ABS resins.

10. An improved alignment spacer device according to claim 7 that is thermoformed from a laminate of olefin and acrylic resins.

11. An improved alignment spacer device according to claim 7 that is thermoformed from a laminate of olefin and PVC resins.

12. An improved alignment spacer device according to claim 7 that is thermoformed from a laminate of polypropylene and styrene resins.

13. An improved alignment spacer device according to claim 7 that is thermoformed from a laminate of polypropylene and ABS resins.

14. An improved alignment spacer device according to claim 7 that is thermoformed from a laminate of polypropylene and acrylic resins.

15. An improved alignment spacer device according to claim 7 that is thermoformed from a laminate of polypropylene and PVC resins.

16. An improved alignment spacer device according to claim 7 that is thermoformed from a laminate of nylon and styrene resins.

17. An improved alignment spacer device according to claim 7 that is thermoformed from a laminate of nylon and ABS resins.

18. An improved alignment spacer device according to claim 7 that is thermoformed from a laminate of nylon and acrylic resins.

19. An improved alignment spacer device according to claim 7 that is thermoformed from a laminate of nylon and PVC resins.

20. An improved alignment spacer device according to claim 7 that is thermoformed from a laminate of acetal and styrene resins.

21. An improved alignment spacer device according to claim 7 that is thermoformed from a laminate of acetal and ABS resins.

22. An improved alignment spacer device according to claim 7 that is thermoformed from a laminate of acetal and acrylic resins.

23. An improved alignment spacer device according to claim 7 that is thermoformed from a laminate of acetal and PVC resins.

24. An improved alignment spacer device according to claim 7 that is thermoformed from a laminate of fluropolymer and styrene resins.

25. An improved alignment spacer device according to claim 7 that is thermoformed from a laminate of fluropolymer and ABS resins.

26. An improved alignment spacer device according to claim 7 that is thermoformed from a laminate of fluropolymer and acrylic resins.

27. An improved alignment spacer device according to claim 7 that is thermoformed from a laminate of fluropolymer and PVC resins.
